(19) United States
(12) Patent Application Publication
(10) Pub. No.: US 2026/0194195 A1
(43) Pub. Date: Jul. 9, 2026

(54) PRE-WIRED QUICK CONNECT LIGHTING SYSTEMS AND KITS THEREOF

(71) Applicant: DALS LIGHTING INC., Blainville (CA)

(72) Inventors: Maxime LALONDE, Blainville (CA); Andreanne LAVOIE, Blainville (CA); Jeremie SAINT-ANDRE, Blainville (CA)

(21) Appl. No.: 19/443,880

(22) Filed: Jan. 8, 2026

(30) Foreign Application Priority Data
Jan. 8, 2025 (CA) 3,261,623

(51) Int. Cl. F21S 8/04; F21S 2/00; F21V 21/108; F21V 21/26; F21V 23/00; F21V 23/06; F21Y 115/10

(52) U.S. Cl. CPC F21S 8/046; F21S 2/005; F21V 21/108; F21V 21/26; F21V 23/002; F21V 23/06; F21Y 2115/10

(57) ABSTRACT

The present description relates to pre-wired lighting systems that include a stem with a tubular housing and opposed mechanical and electrical connection assemblies for providing lighting systems with facilitated installation. The opposed electromechanical connection assemblies are configured to mechanically and electrically interconnect, such that when the stem is assembled end-to-end with an additional stem, a male connector of the stem is mechanically secured within a female connector of the additional stem; and an electrical male terminal of the stem is received within an electrical female terminal of the additional stem to provide electrical contact. There is also provided a lighting kit including the pre-wired lighting system, a canopy, and a fixture body and a method of assembly thereof.

### CROSS-REFERENCE TO RELATED APPLICATIONS

This application claims priority under 35 USC § 119(a) of Canadian patent application 3,261,623 filed on Jan. 8, 2025, the specification of which is hereby incorporated by reference.

### TECHNICAL FIELD

The technical field generally relates to lighting systems and more particularly to lighting fixtures with pre-wired and quick connect features.

### BACKGROUND

Lighting systems, and most notably lighting fixtures, can vary in their design and in their type of intended installation. For example, some fixtures can be installed on flat ceilings, whereas others can be installed in slanted or hard-to-reach ceilings. Some lighting fixtures can have a pendant design, others can have a flush configuration, while others can have a lamp configuration. Given the varying types of lighting fixtures, the various installation settings possible, the required knowledge to properly install them and avoid associated injuries or dangers, and the specialized equipment that can sometimes be required to do so, it can be challenging to assemble, repair, or replace lighting fixtures. With the various challenges with respect to lighting systems, assembly and use, there is a need for a lighting system that is easier for an end user to install, uninstall, repair, or replace.

### SUMMARY

Various techniques are described herein with respect to lighting systems and related kits and uses.

In some implementations, there is provided a lighting system comprising: a pre-wired lighting stem comprising a tubular housing having a first end and a second end; a first connection assembly comprising a male connector mounted within the first end; and an electrical male terminal mounted within the male connector. The pre-wired lighting stem also includes a second connection assembly comprising: a female connector provided within the second end; and an electrical female terminal mounted within the second end. The pre-wired lighting stem also includes an electrical wiring extending between the electrical male terminal and the electrical female terminal to provide electrical connection therebetween. The first and second connection assemblies are configured to mechanically and electrically interconnect, such that when the pre-wired lighting stem is assembled end-to-end with an additional pre-wired lighting stem: the male connector of the pre-wired lighting stem is mechanically secured within the female connector of the additional pre-wired lighting stem; and the electrical male terminal of the pre-wired lighting stem is received within the electrical female terminal of the additional pre-wired lighting stem to provide electrical contact.

In some implementations, the electrical wiring comprises two or more wires. In some implementations the male connector and the female connector mechanically interconnect via threads. In some implementations the female connector is integral with an interior surface of the tubular housing. In some implementations the male connector has a proximal part fixed within the tubular housing and a distal part protruding from the tubular housing. In some implementations there is a plurality of the pre-wired lighting stems having different lengths. In some implementations the first and second connection assemblies are sized and configured such that completion of mechanical interconnection of the male and female connectors causes the electrical contact between the electrical male terminal and the electrical female terminal. In some implementations the electrical male terminal comprises a pin extending longitudinally from a center of the tubular housing. In some implementations the electrical female terminal comprises a recess socket extending longitudinally along a center of the tubular housing. In some implementations the first and second connection assemblies are fixed with respect to the tubular housing. In some implementations the first and second connection assemblies are secured to the tubular housing, optionally with a threaded connection with lock tight and/or welding.

In some implementations, there is provided a lighting kit comprising: a plurality of the lighting systems comprising the pre-wired lighting stem as described or illustrated herein, the plurality of the pre-wired lighting stems comprising at least two different lengths; a canopy comprising a canopy connection assembly configured to mechanically and electrically connect to one of the pre-wired lighting stems; and a fixture body comprising a fixture body connection assembly configured to mechanically and electrically connect to one of the pre-wired lighting stems.

In some implementations, the canopy connection assembly has a female configuration. In some implementations the fixture body connection assembly has a male configuration. In some implementations the canopy or the fixture body is pre-wired to a switch. In some implementations, the switch is a correlated colour temperature (CCT) switch. In some implementations, the plurality of the pre-wired lighting stems comprises stems of three or more different lengths. In some implementations, one or more of the pre-wired lighting stems comprises stems having one or more of the following configurations: straight, curved, elbows, angled, U-shaped, V-shaped, Y-shaped, one-to-three branched configuration, and flexible arm configuration.

In some implementations, there is provided a lighting system comprising: a pre-wired lighting stem comprising a tubular housing having a first end and a second end. The pre-wired lighting stem also includes a first connection assembly comprising: a first mechanical connector mounted at the first end; and an electrical male terminal mounted at the first end. The pre-wired lighting stem includes a second connection assembly comprising: a second mechanical connector provided at the second end; and an electrical female terminal mounted at the second end. The pre-wired lighting stem also includes electrical wiring extending between the electrical male terminal and the electrical female terminal to provide electrical connection therebetween. The system is configured such that the first and second connection assemblies mechanically and electrically interconnect, such that when the pre-wired lighting stem is assembled end-to-end with an additional pre-wired lighting stem: the first mechanical connector of the pre-wired lighting stem is mechanically secured to the second mechanical connector of the additional pre-wired lighting stem; and the electrical male terminal of the pre-wired lighting stem is received within the electrical female terminal of the additional pre-wired lighting stem to provide electrical contact.

In some implementations, the first and second mechanical connectors are configured to provide male-female interconnection. In some implementations, the first mechanical connector is a male connector and the second mechanical connector is a female connector. The connection assemblies can be constructed such that the mechanical connector and corresponding electrical terminal are components that are coupled together when assembled, or such that the mechanical connector and corresponding electrical terminal are integral with each other forming a single component.

### BRIEF DESCRIPTION OF THE DRAWINGS

The attached figures illustrate various features, aspects and implementations of the technology described herein.

FIG. 1 is a side elevation cross-sectional view of an example pre-wired lighting stem.

FIG. 2 is a perspective local view of a male electromechanical connection on an example pre-wired lighting stem.

FIG. 3 is a perspective local view of a female electromechanical connection on an example pre-wired lighting stem.

FIG. 4 is an exploded side elevation view of an example male electromechanical connection.

FIG. 5 is a top plan view of the example male electromechanical connection of FIG. 4.

FIG. 6 is an exploded side elevation view of an example female electromechanical connection.

FIG. 7 is a top plan view of the example female electromechanical connection of FIG. 6.

FIG. 8 is a side elevation view of an example lighting system including pre-wired lighting stems, a canopy, and a light fixture.

FIG. 9 is a top perspective view of a canopy of an example lighting system.

FIG. 10 is a bottom perspective view of a canopy of an example lighting system including a female electromechanical connection.

FIG. 11 is a top perspective view of a light fixture of an example lighting system including a male electromechanical connection and a switch.

FIG. 12 is a top perspective view of an example kit of lighting stems from complete assembly to exploded see-through view.

FIG. 13 is a top perspective view of another example kit of lighting stems from complete assembly to exploded view.

FIG. 14 is illustrating side elevation and side sectional views of a lighting stems kit including different examples of stems.

FIG. 15 is a side elevation view of a lighting kit for assembling an example pre-wired lighting system.

FIG. 16 is illustrating an exploded view of different steps of an installation method for assembling an example pre-wired lighting system, including a detailed view of a switch disposed on a fixture body.

FIG. 17 is a side elevation view of an example lighting system with a canopy including multiple electromechanical connections, each connected to a different pre-wired lighting stem.

FIG. 18 is a side elevation view of another example lighting system with multiple lighting fixtures connected to an intermediary canopy.

FIG. 19 is a side perspective view of a pivotable connection assembly for an example lighting system, embodied as an adapter assembly.

FIG. 20 is a side cross-sectional view of the pivotable connection assembly of FIG. 19.

FIG. 21 is a perspective view of an example lighting system installed on a slanted ceiling and including a pivotable connection assembly.

### DETAILED DESCRIPTION

The present description relates to lighting systems, and notably to lighting systems with rapid and easy assembly capabilities. In some implementations, the lighting system, also referred to as light system, includes pre-wired stems that include mechanical and electrical connectors to facilitate interconnection of multiple stems in end-to-end relation during installation of the lighting system. The lighting system can also include a canopy and fixture body, each of which has corresponding connector capabilities for connection to the stem assembly.

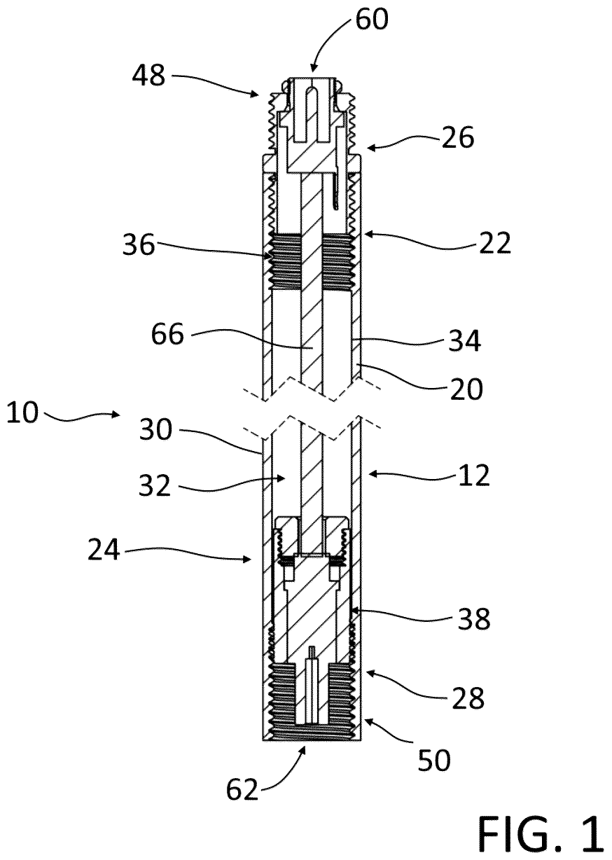

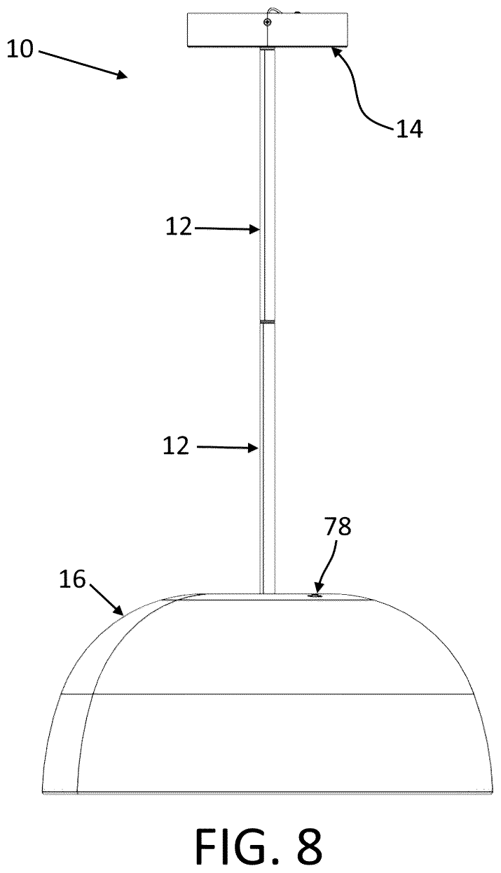

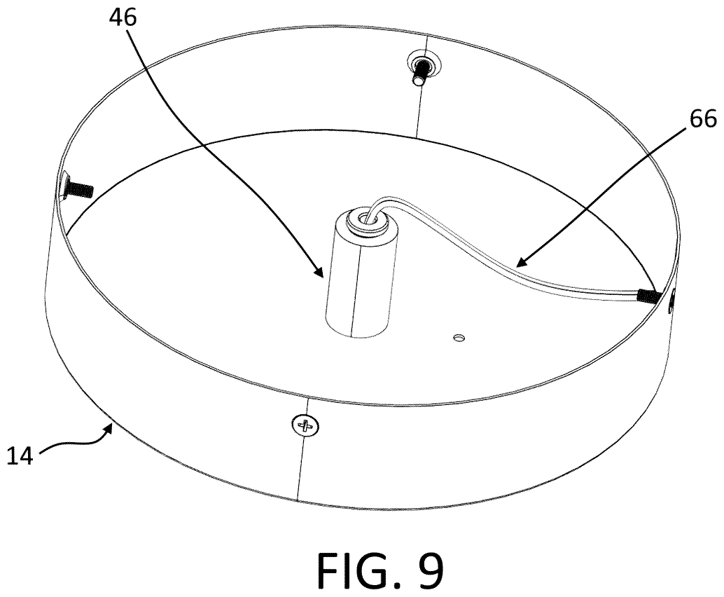

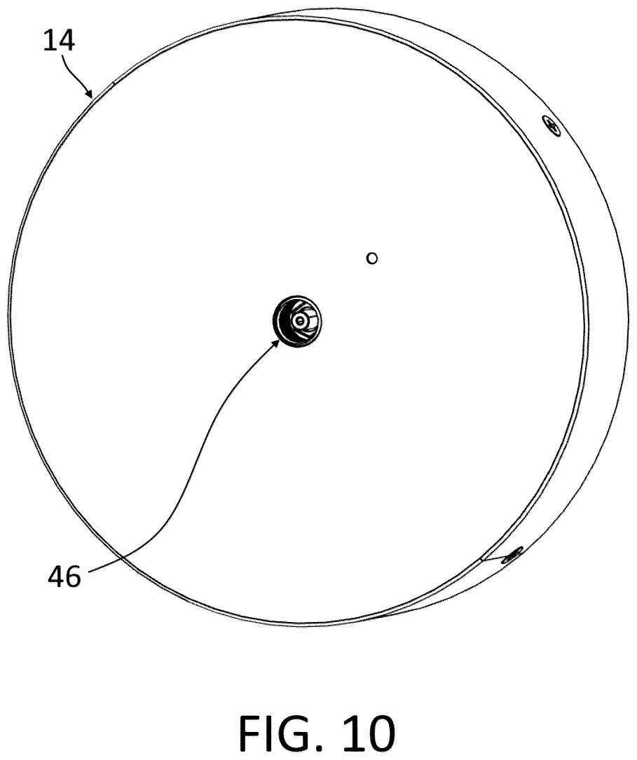

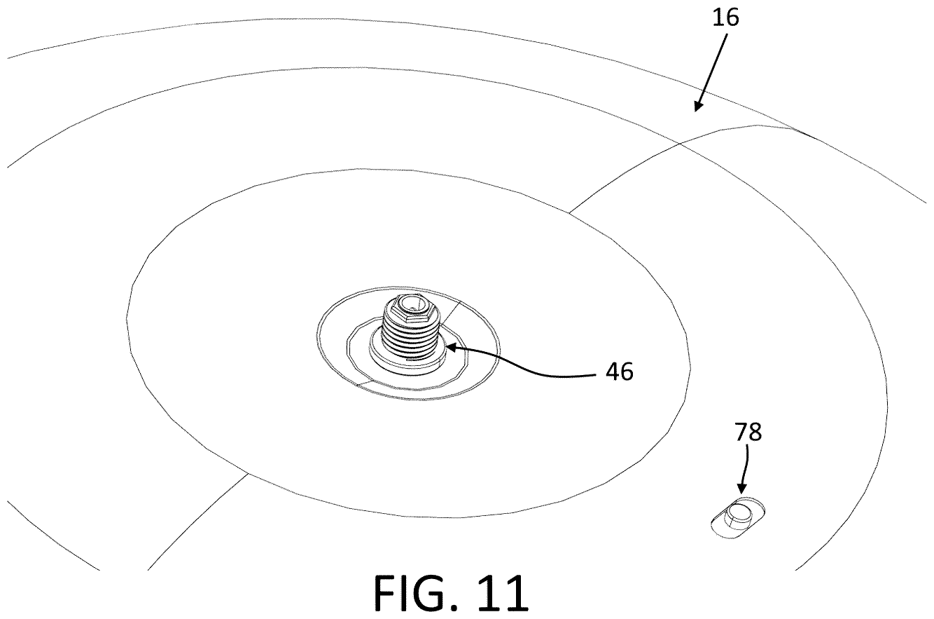

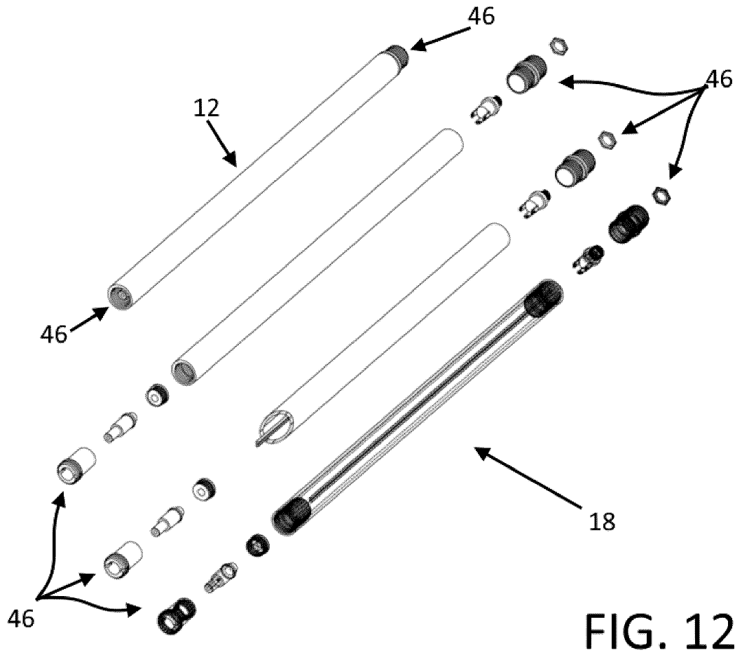

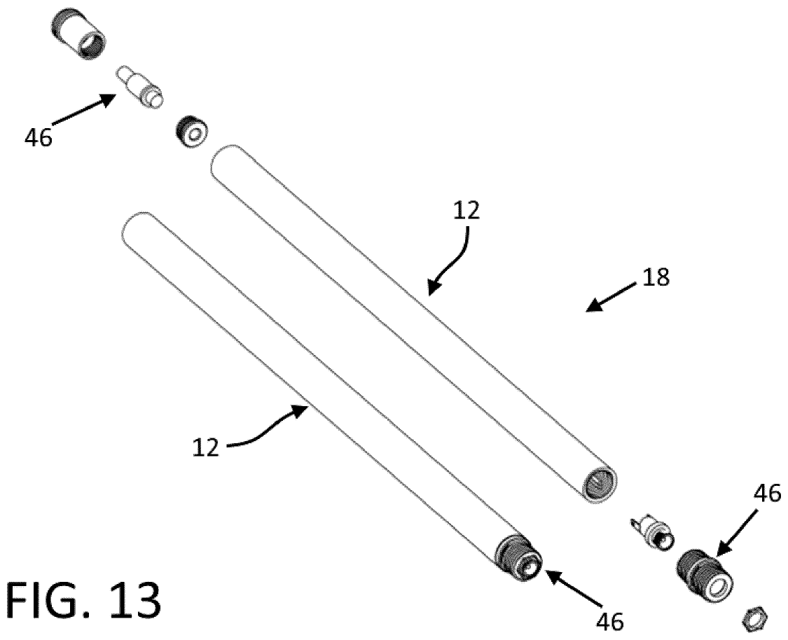

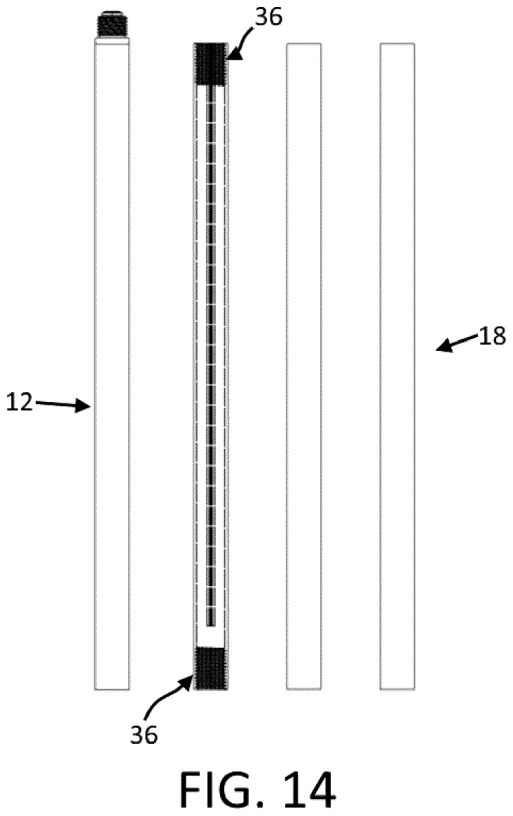

Referring to FIG. 1, the lighting system 10 includes a pre-wired lighting stem 12. The lighting stem 12 is pre-wired and has mechanical and electrical components that facilitate interconnection and coupling with other complementary systems. For example, such additional systems can be another lighting stem, or a canopy body 14 and a fixture body 16, both shown in FIGS. 8 to 11, 15 and 16. A stem assembly can therefore be formed by coupling a plurality of pre-wired lighting stems 12 together. Multiple lighting stems 12, optionally having different lengths, can be provided as part of a kit 18, as shown in FIGS. 12 to 15, to enable a user to assemble a desired length or configuration of the stem assembly.

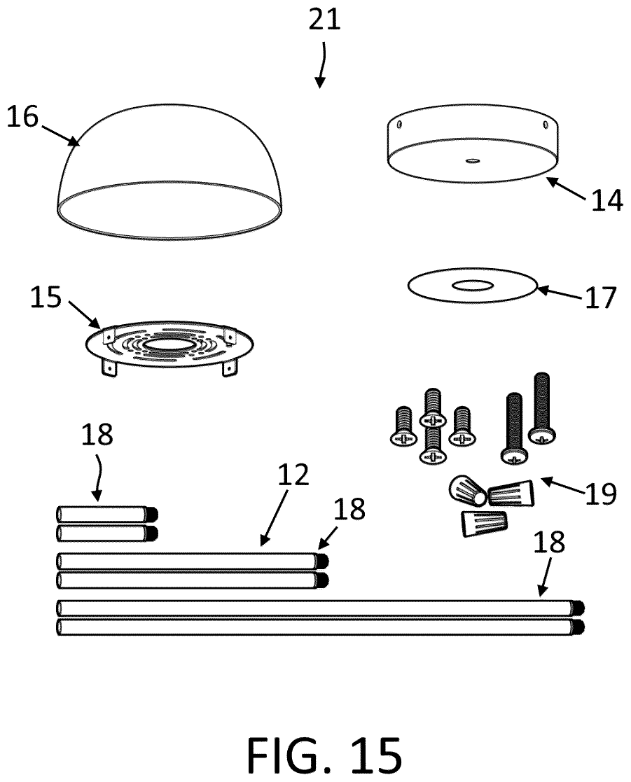

Referring to FIG. 15, a lighting kit 21 for the pre-wired lighting system 18 that includes the canopy body 14 and the fixture body 16 can be used with different kits 18 of lighting stems 12, either to retain a similar stem configuration or to obtain different stems configuration. The stem kits 18 can each include stems 12 of different lengths. The lighting kit 21 can also include a mounting bracket 15 for mounting the canopy 14 to an electrical box disposed in a wall or ceiling, a protective gasket 17 configured to be disposed between two components of the kit 21, and fastening means 19 for fastening the components of the kit 21 during installation.

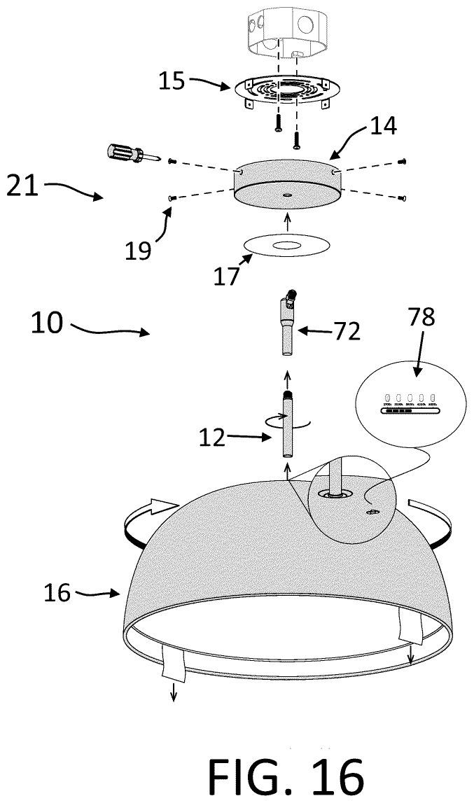

Referring now to FIG. 16, an exploded view of an installation method 100 of the lighting system 10 or of a lighting kit 21 is shown. The method 100 can include the steps of: fastening the mounting bracket 15 to the electrical box disposed in a building surface, such as a wall or a ceiling; fastening the canopy 14 to the mounting bracket 15; disposing the protective gasket 17 on the canopy 14 such that it surrounds the electromechanical connection parts 46 of the canopy 14; connecting the pre-wired lighting stems 12 to the canopy 14; and connecting the fixture body 16 to the lighting stems 12. The method 100 can also include connecting an adapter pivot assembly 72 between any of the components of the system 10. In some examples, the steps of the method 100 can be reordered differently. In another example, uninstalling the lighting system 10 can include steps opposite to the steps of the method described herein. Fastening the components of the lighting system 10 can include using fasteners 19, like screws, without specialized equipment, i.e., by using a screwdriver or a drill, for example.

Referring back to FIG. 1, the exemplary pre-wired lighting stem 12 includes a tubular housing 20 having a first end 22 and a second end 24, a first connection assembly 26 at one of the two ends, at the first end 22 for example, and a second connection assembly 28 at the other of the two ends, at the second end 24 for example. The tubular housing 20 can be a straight tube 30 defining a channel 32 with an inside surface 34 spanning from end-to-end 22, 24 thereof. Fastening means 36 can be provided at one or both of the tubular housing ends 22, 24 to secure the tubular housing 20 to another component of the lighting stem 12, such as to the connection assemblies 26, 28. In the example shown, the tubular housing 20 includes threads 36 on its interior surface 34 being configured to engage with threads of the counterpart component of the lighting stem 12.

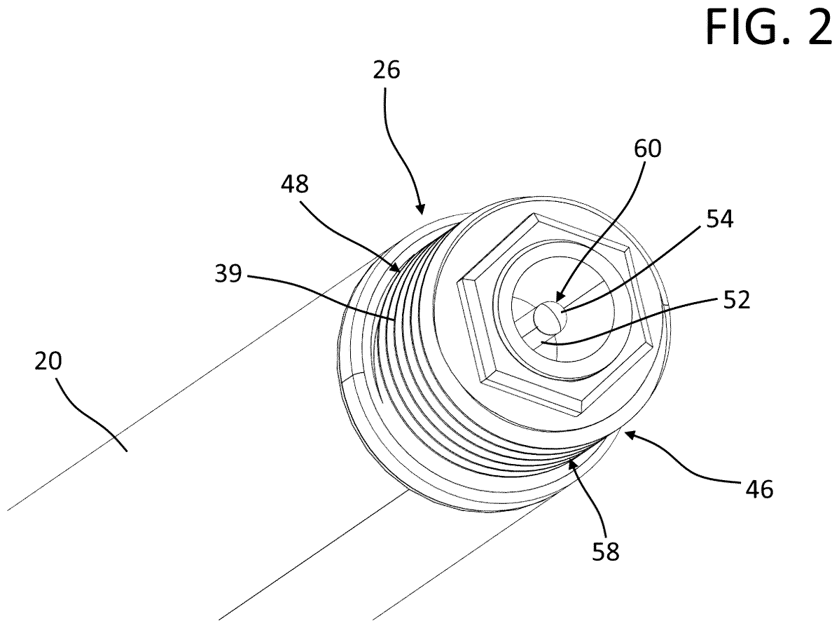

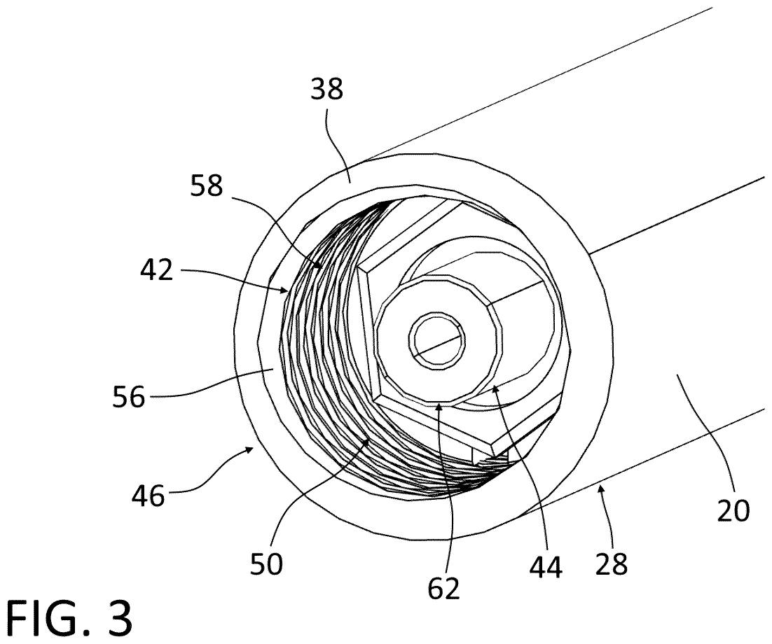

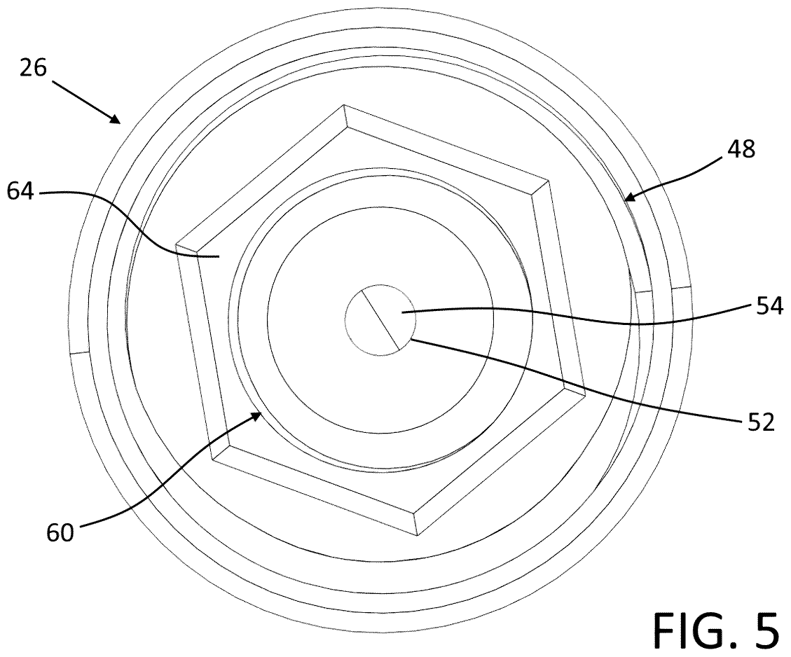

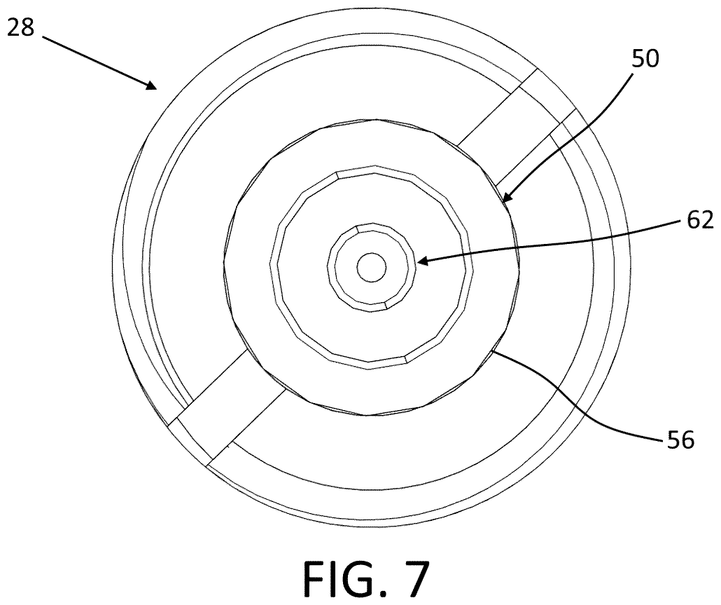

Referring to FIGS. 2 to 7, the connection assemblies 26, 28 can be manufactured separately from the tubular housing 20 or manufactured unitarily. When manufactured separately from the tubular housing 20, the connection assemblies 26, 28 can be temporarily or permanently fastened to the tubular housing 20. In embodiments in which the connection assemblies 26, 28 are manufactured separately from the tubular housing 20, the connection assemblies 26, 28 can include a tubular body 38 having a shape and size designed to engage with the ends 22, 24 of the tubular housing 20, for example threads 39 disposed on an outward facing 40 surface of the connection assembly 26, 28 configured to engage with the threads 36 on the interior surface 34 of the tubular housing 20. Each of the first and second connection assemblies 26, 28 can include a mechanical connector 42 and an electrical terminal 44, the combination being referred to as electromechanical connection 46, allowing mechanical and electrical coupling to a corresponding connector or terminal respectively.

The mechanical connector 42 can be a male 48 or female 50 connector mounted within or outside the connection assembly 26, 28. In the examples shown, the male connector 48 is mounted to the connection assembly 26 and the female connector 50 is mounted to the other connection assembly 28. In some examples, the male connector 48 can be mounted outside the connection assembly 26, 28, for example on an outer surface 40 of the tubular body 38 of the connection assembly 26, 28. In other examples, the male connector 48 can be mounted inside the connection assembly 26, 28, for example on an outward-facing surface 52 of a tubular projection 54 provided within the connection assembly 26, 28. In yet other examples, the female connector 50 can be mounted inside the connection assembly 26, 28, for example on an inward facing surface 56 of the tubular body 38 of the connection assembly 26, 28.

The mechanical connector 42 can include temporary or semi-permanent fastening means 58, which can be one or more of threads, clips, and soft locks, e.g., a friction surface or a magnetic connection, to connect with a corresponding mechanical connector 42 of the tubular housing 20 or of a counterpart lighting stem 12. The mechanical connector 42 can thus be temporarily or detachably secured to the tubular housing 20 of the lighting stem 12, such that it can be removed and replaced by another mechanical connector 42 if desired. As shown, the male connector 48 of the connection assembly 26, 28 includes fastening means 58 on the outward facing surface 52 of the tubular projection 54 provided within the tubular body 38 of the connection assembly 26, 28. The female connector 50 can thus include fastening means 58 on an inward facing surface 56 of the tubular body 38 of the connection assembly 26, 28 such that it can connect with a counterpart male connector 42 having corresponding fastening means 58. The first and second connection assemblies 26, 28 can include both male 48 and female 50 connectors simultaneously. For example, in the connection assembly 26, 28, fastening means 58 can be provided both on the inward facing surface 56 of the tubular body 38 and on the outward facing surface 40 of the tubular body 38.

In other embodiments, the connection assemblies 26, 28 can be permanently secured to the tubular housing 20 of the lighting stem 12, e.g., by being manufactured unitarily or with permanent fastening means 58. The mechanical connector 42 can thus include permanent fastening means 58 obtained through fastening methods such as soldering, brazing, welding, gluing, thermal expansion fitting, etc. In some examples, the lighting system 10 can have one of the two connection assemblies 26 or 28 permanently fastened to the tubular housing 20 and the other of the two connection assemblies 26 or 28 temporarily fastened to the tubular housing 20.

The electrical terminal 44 can be a male electrical terminal 60 or a female electrical terminal 62 provided within the connection assembly 26, 28. The electrical terminal 44 can be provided within the tubular body 38 of the connection assembly 26, 28 and can also be provided within the mechanical connector 42. In the example shown, the first connection assembly 26 includes a male connector 48 with a pin protruding within the tubular body 38 of the first connection assembly 26, and an electrical male terminal 60 provided within the male connector 48. The second connection assembly 28 includes a female connector 50 mounted within the tubular body 38 of the second connection assembly 28, on the inward facing surface 34 of the tubular housing 20, and an electrical female terminal 62 provided centrally in the tubular body 38. In other examples of connection assemblies 26, 28, the male terminal 60 can be provided with the female connector 50 and the female terminal 62 can be provided within the male connector 48. A nut 64 can be provided to engage with the one or both of the electrical terminal 44 and mechanical connector 42 to prevent withdrawal of the electrical terminal 44 from within the mechanical connector 42 or the connection assembly 26, 28.

It can be appreciated that the mechanical connector 42 and the electrical terminal 44 can be substantially or fully housed within the tubular housing 20 when engaged thereto, such that no particular portions protrude out of the lighting stem 12, at least transversally, and at the very least when assembled to complementary systems. In examples in which some portions of the mechanical connectors 42 or electrical terminals 44 protrude out of the lighting stem 12, the protruding portions can be configured to be substantially or fully received and housed by the complementary system such that no portions protrude out of the stem assembly thereof.

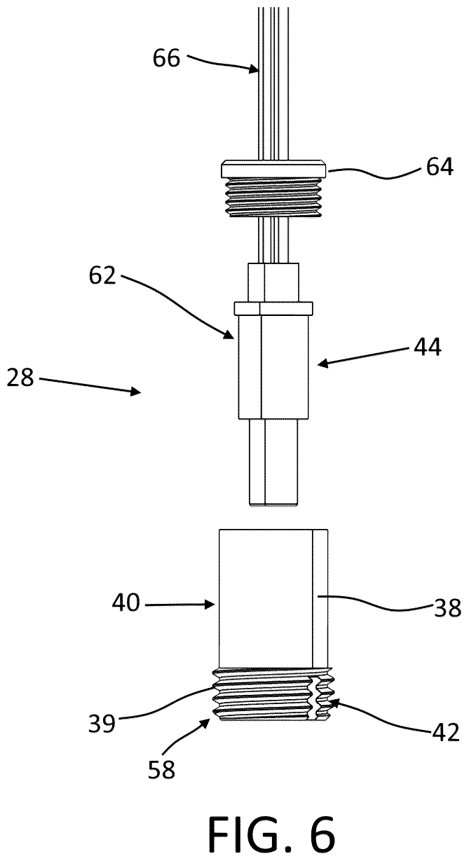

Referring back to FIG. 1, the pre-wired lighting stem 12 includes electrical wiring 66, also shown in FIG. 6, extending between the electrical male terminal 60 and the electrical female terminal 62 to provide electrical connection therebetween. Electrical contact between the first and second ends 22, 24 of the lighting stem 12 can therefore be assured due to the electrical wiring 66 extending between the end-to-end terminals 60, 62. In different embodiments, the type, number and configuration of electrical wirings 66 within the pre-wired lighting stem 12 can vary.

The first and second connection assemblies 26, 28 are configured to mechanically and electrically interconnect, such that when one pre-wired lighting stem 12 is assembled end-to-end with another pre-wired lighting stem 12, the male connector 48 of one of the pre-wired lighting stems 12 is mechanically secured to the female connector 50 of the other of the pre-wired lighting stems 12, and the electrical male terminal 60 of one of the pre-wired lighting stems 12 is received by the electrical female terminal 62 of the other of the pre-wired lighting stems 12, thereby providing electrical connection between the two ends 22, 24. Two or more of the pre-wired lighting stems 12 can thus be interconnected in end-to-end fashion to form an assembled stem 12 that is both electrically functional and mechanically solid in the assembled state.

The electrical terminal 44 can be of various types and configurations - such as low-voltage DC plug, receptacle, and slip ring. The illustrated version has two terminals 44, but it is noted that more terminals 44 can be used, e.g., three or more. It can further be noted that there can be more than one electrical terminal 44 in a single connection assembly 26, 28. Wiring 66 in the lighting stems 12 can pre-soldered to the quick electrical terminals 44 on both ends 22, 24 of the stems 12, which means that no hardwiring is required. When the lighting stems 12 are coupled together or coupled to the canopy 14 or fixture 16, electrical contact is automatically established through the electrical connectors 44. The electrical wires 66 act as jumpers to transfer current between male 60 and female 62 electrical terminals; the wires 66 can be slightly longer than the tubular housing 20 of the stem 12 to simplify soldering with excess wire 66 being tucked inside the tubular housing 20 of the stem 12 during manufacturing or assembly. In the pre-wired stem 12, the wires 66 can no longer be visible or accessible to the end user, but rather hidden within the central cavity 32 of the tubular housing 20 and shielded by the connection assemblies 26, 28. In some examples, there can be two or more wires 66 in a pre-wired stem 12.

In some examples, such as those of FIGS. 12 to 15, the stem kits 18 can include pre-wired lighting stems 12 of the same or different lengths. Although not limitative, the lighting stems 12 can have a length of about 4 inches, 12 inches, 24 inches and 36 inches. An end user can therefore select the length and quantity of stems 12 and implement the stem assemblage as needed or desired. Additional stems 12 can also be obtained individually and not part of the kit 18 if needed by the user, and custom lengths are also possible. The stems 12, and specifically the tubular housing 20, can be made of material that comprises one or a combination of metal, such as steel or aluminum, or plastic. The stems 12 can be made of a material that is substantially the same as the material of the canopy body 14 and the fixture body 16.

Although the shown pre-wired lighting stem 12 of FIG. 1 has a straight tubular shape, alternative configurations of pre-wired lighting stems 12 with different shapes can also be included. For example, the lighting stem 12 can have three or more ends with three or more connection assemblies. The lighting system 10 can thus facilitate modular construction where the lighting stems 12 provided in the assembly or kit 18 can be selected and assembled for a desired overall length and configuration depending on the intended application. The tubular housing 20 of the lighting stem 12 can be rigid or flexible and can be a single straight housing or can have various other configurations, e.g., curved, elbow, angled, U-shaped, V-shaped, Y-shaped, one-to-three branched configuration, and so on. The tubular housing 20 of the lighting stem 12 can also include multiple compartments, i.e., the tubular housing 20 can house multiple concentric longitudinal tubes which can increase the structural integrity of the stem 12 while allowing passage of the wires 66 or other components therebetween. The tubular housing 20 can further include brackets in the channel 32 for supporting and holding in position the wires 66 or other components passing through the channel 32. The stem assembly or kit 18 can therefore include pre-wired lighting stems 12 of different sizes, shapes, and configurations.

Referring to FIGS. 8 to 11, in addition to the one or more pre-wired lighting stems 12, the lighting system 10 can also include at least one of the canopy 14 and the fixture body 16, both having electromechanical connection parts 46 for electrically and mechanically connecting with the pre-wired lighting stems 12. The canopy 14 can include a female-type connection assembly while the fixture body 16 can include a male-type connection assembly, for example. The canopy 14, the fixture body 16, and the lighting stems 12, can include a switch 78 accessible to a user for controlling parameters of the pre-wired lighting system 10. For example, and shown in FIGS. 8, 11 and 16, the switch 78 can be a correlated colour temperature (CCT) switch disposed on the fixture body 16 and configured to control the color temperature of light emitted by the fixture body 16.

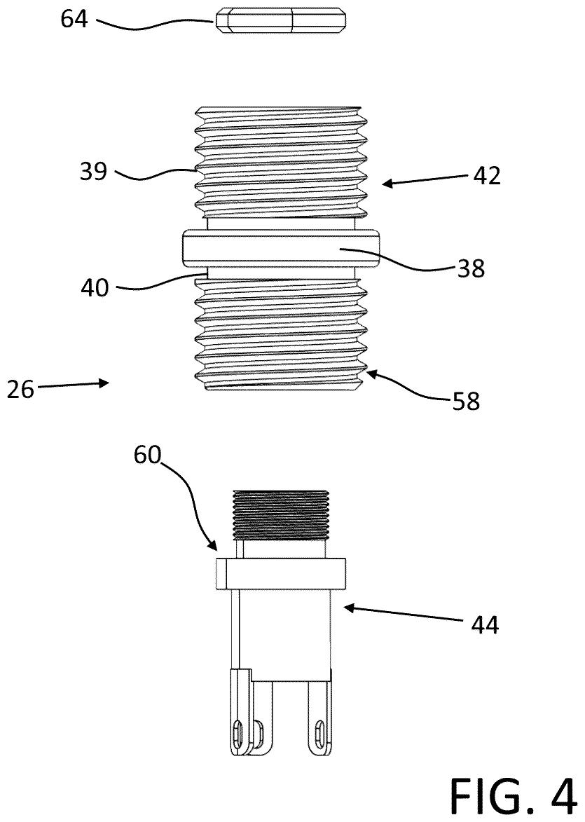

The electromechanical connections 46, and more precisely the electrical terminals 44 and the mechanical connectors 42, can have various constructions and configurations, some of which have been previously described. For example, as shown in FIGS. 4 and 6, the mechanical connectors 42 can have threads 39 for interconnection between male 48 and female 50 connectors. It is also possible to have other types of mechanical connection structures. The electrical terminal structures 44 can also have a male 60 and female 62 construction. It can therefore be appreciated that the electromechanical connection 46 of the pre-wired lighting stem 12 with another stem 12, to the canopy 14, and to the fixture body 16 can thus reasonably be achieved by the end user without prior knowledge and expertise in this field and without specialized equipment to boot.

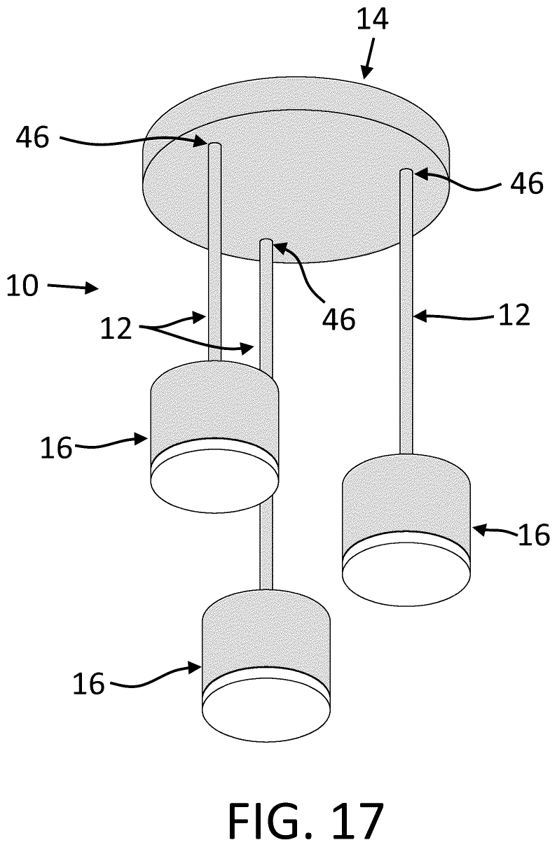

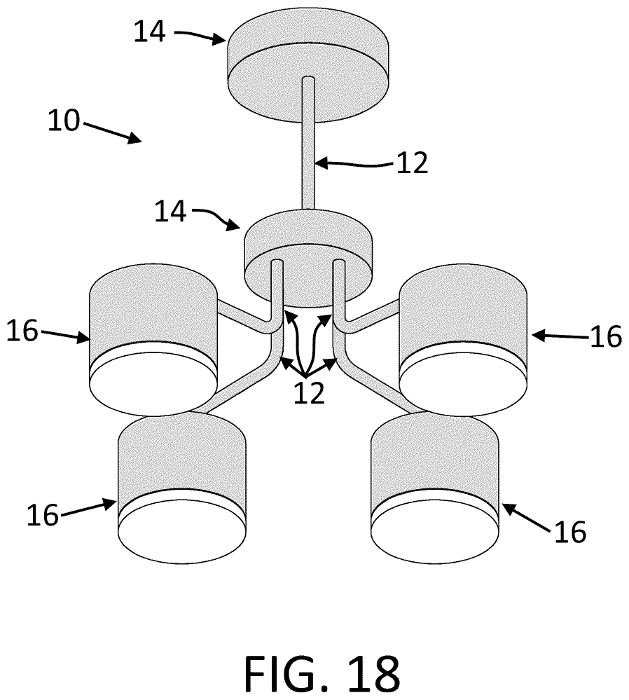

It is also noted that in some examples, the lighting system 10 can be configured such that the use of stems 12 can be avoided by directly assembling the fixture body 16 to the canopy 14, both comprising electromechanical connections 46 as previously described. In yet further examples, in addition to the canopy 14, the lighting system 10 can include a plurality of fixture bodies 16, which can be connected to one another with the described electromechanical connections 46. As shown in FIG. 17, a single canopy 14 can include multiple electromechanical connections 46, such that it can be configured to couple to multiple lighting stems 12. Another variation of the lighting system 10 configuration is shown in FIG. 18, in which a single lighting stem 12 is connected to the canopy 14, and to which is further connected an intermediary canopy 14. From the intermediary canopy 14, multiple lighting stems 12 coupled to a lighting body 16 are connected thereto. Other embodiments of the lighting system 10 with different configurations and number of canopies 14, fixture bodies 16, and lighting stems 12 can be envisioned.

In further examples, the lighting system 10 can be configured such that one of the fixture bodies 16 is positioned and electromechanically connected between two of the stems 12, such that additional stems 12 and fixture bodies 16 can be connected thereafter.

It can also be possible to implement the lighting system 10 in a flush mount configuration, where the lighting system 10 is directly assembled on the canopy 14 and the shade fixture body 16 is configured and shaped, e.g., embossed, to allow for a flush fit with the ceiling, wall, or floor surface to which the canopy 14 is installed to; this option facilitates preventing internal nuts or other retention structures of the canopy from falling out and ensures the canopy 14 sits flush with the shade 16.

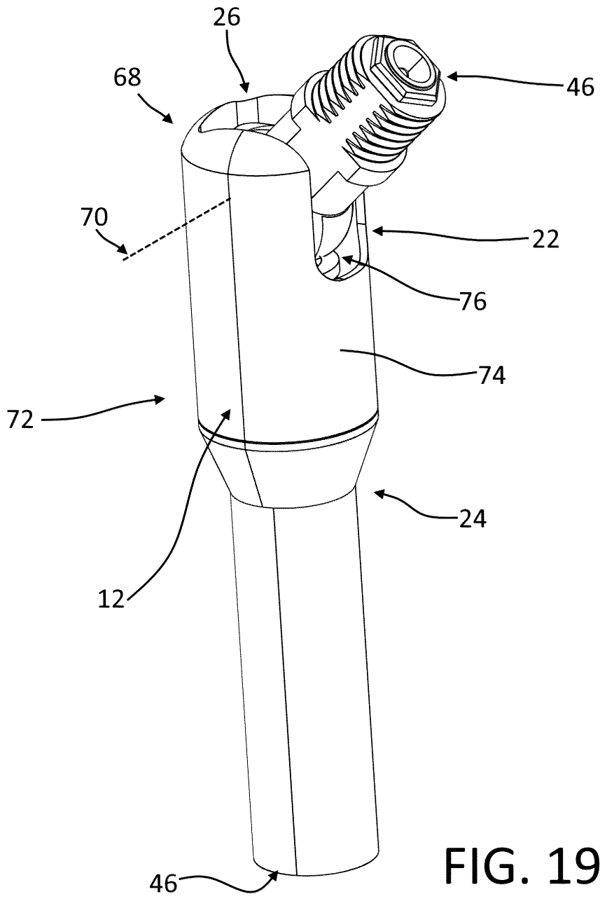

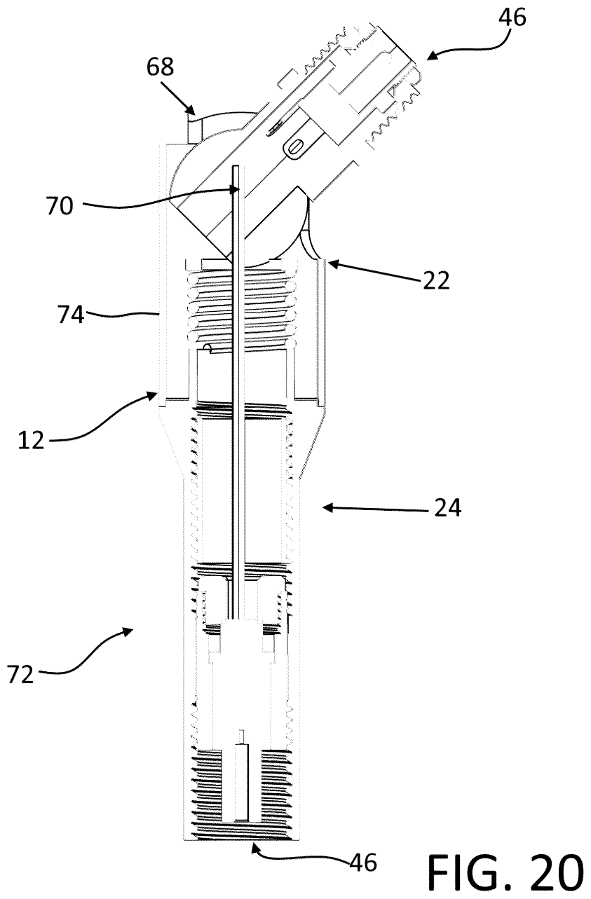

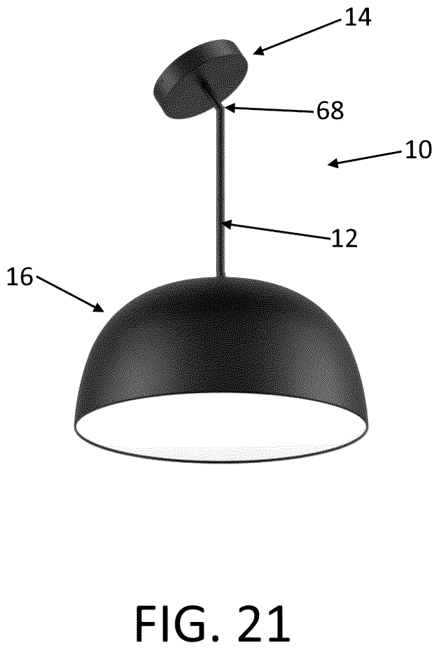

Referring to FIGS. 19 and 20, the lighting stem 12 has an elbow configuration with a pivot assembly 68. In this embodiment, the pivot assembly 68 is a pivotable connection assembly at one of the ends 22, 24 of the lighting stem 12. The connection assembly 26, 28 has a pivot axis 70 at the end of the tubular housing 20, thus producing a crease in the elbow. Because the connection assembly 26, 28 is pivotable about the end 22, 24 of the tubular housing 20, the crease angle of the elbow configuration can be adjusted depending on the desired configuration of the lighting system 10. The pivot of the connection assembly 26, 28 therefore allows connecting the stems 12 and the fixture bodies 16 to the canopy 14 in a configuration in which one or more of the lighting system 10 components have different alignments. As shown in FIG. 21, this can be specifically useful when the surface supporting the lighting system 10, e.g., the ceiling, is slanted or angled with respect to the horizontal plane. The exemplified pivotable connection assembly 68 pivots about a single axis, however, in other examples, the pivotable connection assembly 68 can pivot about any number of axes. In one embodiment with multiple degrees of freedom, the pivotable connection assembly 68 can rotate about the tubular housing 20.

In other examples, the pivotable connection assembly 68 can be provided on the fixture bodies 16 or the canopy 14 instead. In yet other examples, the tubular housing 20 can be divided in two or more longitudinal sections connected in an end-to-end configuration, with at least one pair of adjacent longitudinal sections being pivotally connected to one another. Other angle and positioning adjustment mechanisms of the components of the lighting system 10 can also be conceived. For example, the lighting stem 12 can have a variable length, e.g., due to telescopic assembly of a plurality of the tubular housing sections or to stretchable material.

The pivot assembly 68 can also be provided as an adapter 72, manufactured independently from the other components of the lighting system 10. The adapter pivot assembly 72 can be configured to be installed between any of the components of the lighting system 10. The adapter pivot assembly 72 has an adapter body 74 with a relatively short length compared to the length of the tubular housing 20 of the stem 12, such that the amount of space taken with respect to the other components of the lighting system 10 can be minimal. The adapter pivot assembly 72 can have any of the above-described features of the pivot assembly 68 and can therefore ease rearrangement of the configuration of the lighting system 10 by the end user. Moreso, the adapter pivot assembly 72 being manufactured separately from the other components of the lighting system 10 allows removal and replacement of the adapter 72 only rather than a complete replacement of the lighting stems 12, fixture body 16, or canopy 14 if need arises.

The pivot assembly 68 of the lighting system, whether it's on the connection assembly 26, 28 or on another component thereof, can include a pivot lock 76 to prevent pivot and rotation of the pivot assembly 68. The pivot lock 76 can include any mechanism allowing rotational stopping of the pivot assembly 68, e.g., blocking pins, screws such as headless screws, detents, locking rings, clamps, torque arms, etc. The pivot lock 76 can therefore allow the lighting system 10, or components thereof, to retain a position in an intended configuration that goes against gravity or other external forces.

It will be appreciated that for the lighting system 10 as described herein, the connection assemblies 26, 28 can include several sub-components that are mounted together and with respect to the tubular housing 20. In assembly, the wiring 66 can be passed through the tubular housing 20 and connected to opposed connection assemblies 26, 28, and then the connection assemblies 26, 28 can be mounted in the tubular housing 20 ends 22, 24 to enclose the wiring 66.

The lighting systems 10 described herein can be used in various applications. For example, the lighting system 10 can be used in LED applications, recessed lighting systems, stem-mounted lighting solutions, canopy-to-fixture connections, and the like. The pre-wired systems 10 can facilitate assembly and eliminate hardwiring while allowing a flush mount or pendant installation. In some examples, the lighting system 10 can be wet rated, and thus operable in applications in which fluid, humidity, or moisture exposure is possible or expected. The lighting system 10 can therefore include gaskets, such as rubber gaskets, installed between two components of the lighting system 10 to at least substantially hermetically seal entry of fluids therein.

It is noted that the systems described herein are examples and various changes or variations could be made to the lighting system 10.

1. A lighting system comprising:
a pre-wired lighting stem comprising:
a tubular housing having a first end and a second end;
a first connection assembly comprising:
a male connector mounted within the first end; and
an electrical male terminal mounted within the male connector;
a second connection assembly comprising:
a female connector provided within the second end; and
an electrical female terminal mounted within the second end; and
electrical wiring extending between the electrical male terminal and the electrical female terminal to provide electrical connection therebetween;
wherein the first and second connection assemblies are configured to mechanically and electrically interconnect, such that when the pre-wired lighting stem is assembled end-to-end with an additional pre-wired lighting stem:
the male connector of the pre-wired lighting stem is mechanically secured within the female connector of the additional pre-wired lighting stem; and
the electrical male terminal of the pre-wired lighting stem is received within the electrical female terminal of the additional pre-wired lighting stem to provide electrical contact.

2. The lighting system of claim 1, wherein the electrical wiring comprises two or more wires.

3. The lighting system of claim 1, wherein the male connector and the female connector mechanically interconnect via threads.

4. The lighting system of claim 1, wherein the female connector is integral with an interior surface of the tubular housing.

5. The lighting system of claim 1, wherein the male connector has a proximal part fixed within the tubular housing and a distal part protruding from the tubular housing.

6. The lighting system of claim 1, wherein there are a plurality of the pre-wired lighting stems having different lengths.

7. The lighting system of claim 1, wherein the first and second connection assemblies are sized and configured such that completion of mechanical interconnection of the male and female connectors with the corresponding female and male connectors of the additional pre-wired lighting stem causes the electrical contact between the electrical male and female terminals and the electrical female and male terminals of the additional pre-wired lighting stem.

8. The lighting system of claim 1, wherein one or more of the electrical male terminal and the mechanical male connector comprises a projection extending longitudinally from a center of the tubular housing.

9. The lighting system of claim 1, wherein one or more of the electrical female terminal and the mechanical female connector comprises a recess socket extending longitudinally along a center of the tubular housing.

10. The lighting system of claim 1, wherein the first and second connection assemblies are secured permanently or manufactured unitarily with respect to the tubular housing.

11. The lighting system of claim 1, wherein the first and second connection assemblies are temporarily or semi-temporarily secured to the tubular housing.

12. The lighting system of claim 1, wherein the pre-wired lighting stem includes two or more longitudinal sections connected in an end-to-end configuration, with at least one pair of adjacent ones of the longitudinal sections being pivotally connected to one another with a pivot assembly.

13. A lighting kit comprising:
a plurality of the lighting systems comprising the pre-wired lighting stem as recited in claim 1;
a canopy comprising a canopy electromechanical connection configured to mechanically and electrically connect to one of the pre-wired lighting stems; and
a fixture body comprising a fixture body electromechanical connection configured to mechanically and electrically connect to one of the pre-wired lighting stems.

14. The lighting kit of claim 13, wherein the canopy or the fixture body is pre-wired to a switch.

15. The lighting kit of claim 14, wherein the switch is a correlated colour temperature (CCT) switch.

16. The lighting kit of claim 13, wherein the plurality of the pre-wired lighting stems comprises pre-wired lighting stems of two or more different lengths.

17. The lighting kit of claim 13, wherein the plurality of the pre-wired lighting stems comprises pre-wired lighting stems having one or more of the following configurations: straight, curved, elbows, angled, U-shaped, V-shaped, Y-shaped, one-to-three branched configuration, and flexible arm configuration.

18. The lighting kit of claim 13, further comprising an adapter pivot assembly configured to connect between any one of the canopy, the fixture body, and the plurality of the pre-wired lighting stems to allow pivot therebetween.

19. The lighting kit of claim 18, the adapter pivot assembly comprising a pivot lock configured to stop rotation of the adapter pivot assembly when engaged in a locking configuration and configured to allow rotation of the adapter pivot assembly when disengaged from the locking configuration.

20. A lighting system comprising:
a pre-wired lighting stem comprising:
a tubular housing having a first end and a second end;
a first connection assembly comprising:
a first mechanical connector mounted at the first end; and
an electrical male terminal mounted at the first end;
a second connection assembly comprising:
a second mechanical connector provided at the second end; and
an electrical female terminal mounted at the second end;
electrical wiring extending between the electrical male terminal and the electrical female terminal to provide electrical connection therebetween;
wherein the first and second connection assemblies are configured to mechanically and electrically interconnect, such that when the pre-wired lighting stem is assembled end-to-end with an additional pre-wired lighting stem:
the first mechanical connector of the pre-wired lighting stem is mechanically secured to the second mechanical connector of the additional pre-wired lighting stem; and
the electrical male terminal of the pre-wired lighting stem is received within the electrical female terminal of the additional pre-wired lighting stem to provide electrical contact.
